(19) United States
(12) Patent Application Publication
(10) Pub. No.: US 2016/0318113 A1
(43) Pub. Date: Nov. 3, 2016

(54) WELDING AND CUTTING SYSTEM WITH VARIABLE OUTPUT POWER LIMITS

(71) Applicant: Lincoln Global, Inc., City of Industry, CA (US)

(72) Inventors: Edward ENYEDY, Eastlake, OH (US); Adam HRUSKA, Chardon, OH (US)

(21) Appl. No.: 14/700,274

(22) Filed: Apr. 30, 2015

(51) Int. Cl. B23K 9/095; B23K 9/10

(52) U.S. Cl. CPC B23K 9/0953; B23K 9/1006

(57) ABSTRACT

The invention described herein generally pertains to an electric arc generation system providing a variable, allowable output used to form a weld or remove material for purposes of cutting or machining an object. Responsive to a condition of a power supply, the system itself, and/or an environment of the system, the system can determine a limit to an achievable output. The system can control at least one of a settable value for a output or generation of the output to enforce the limit.

### TECHNICAL FIELD

In general, the present invention relates to a system for generating a welding and plasma arc. More particularly, the present invention relates to a system used to perform welding or cutting having a variable output power limit selectively controlled to maintain consistent operation of the welding system.

### BACKGROUND OF THE INVENTION

Welding systems can be designed to operate from one or more power sources individually or in combination. Such power sources include line power (e.g. drawn from the grid), a battery, or a generator driven by an internal-combustion engine or other source of mechanical energy. A welding output of a welding system is derived from an amount of electrical power provided to the welding system from the one or more power sources. Generally, a ratio is between a maximum welding output and the amount of electrical power delivered is governed by combined efficiencies of components of the welding system.

However, changing conditions or circumstances can alter operation of the one or more power sources and, accordingly, affect the welding output that the welding system can produce. For example, a welding system configured to operate with a plurality of power sources will experience a decrease in power delivered when one source of the plurality of power sources becomes unavailable. In another example, the operation of power sources can change according to conditions of the power sources, environmental conditions, conditions of the welding system, or the like. That is, in varying conditions, the power delivered by the power sources also varies.

A welding system attempting to draw more power than available from the power sources can tax the power sources and/or produce an inconsistent welding output. Thus, the power sources, or components related thereto, can be damaged or experience reductions in operational lives. Further, an inconsistent welding output leads to poor welds.

### SUMMARY OF THE INVENTION

Arc welding and cutting involve generation of a arc that is applied to a workpiece. Both processes involve generation of an electrical arc. In welding, the arc is used to join adjacent structures through the application of heat directly to the work piece or to an intermediate product such as a welding stick, rod, wire, flux or the like to melt the materials and form a bond therebetween. An arc may also be applied to perform cutting operations to machine materials by gouging, ablating, or otherwise removing material. For sake of simplicity, both welding and cutting applications will be collectively referred to as a “welding operation.” Likewise, reference to a “welding system” includes an arc generation system and is intended to include both systems that are used to weld and systems that are used to perform cutting or machining.

In accordance with an embodiment of the present invention, a welding system is provided. The welding system can include an interface configured to receive a welding output preset. The welding system can further include a welding power source configured to generate a welding output for performing a welding process. The welding output being based at least in part on the welding output preset received. In addition, the welding system can include a welding controller configured to control the welding power source to generate the welding output. The welding controller is further configured to enforce a limit on the welding output preset

In accordance with another embodiment of the present invention, a method is described. The method includes receiving information indicative of a condition of a welding system. The condition influences an amount of input electrical power deliverable to a welding power source of the welding system for generating a welding output. In addition, the method can include determining a limit on the welding output based on the information indicative of the condition, wherein the limit indicates an achievable welding output due to the condition. Further, the method includes controlling the welding output of the welding system to enforce the limit determined.

In yet another embodiment of the present invention, a computer-readable storage medium is provided. The computer-readable storage medium stores computer-executable instructions. The instruction, when executed by a processor, configure the processor to receive information indicative of a condition of a welding system. The condition influences an amount of input electrical power deliverable to a welding power source of the welding system for generating a welding output. The instructions further configure the processor to determine an achievable welding output due to the condition based on the information indicative of the condition. In addition, the instructions configure the processor to control the welding output of the welding system to constrain the welding output within a limit established by the achievable welding output.

These and other objects of this invention will be evident when viewed in light of the drawings, detailed description and appended claims.

### BRIEF DESCRIPTION OF THE DRAWINGS

The invention may take physical form in certain parts and arrangements of parts, a preferred embodiment of which will be described in detail in the specification and illustrated in the accompanying drawings which form a part hereof, and wherein:

FIG. 1 illustrates an exemplary, non-limiting embodiment of a welding system according to one or more aspects;

FIG. 2 illustrates an exemplary, non-limiting welder in accordance with an aspect;

FIG. 3 illustrates an exemplary, non-limiting welder according to one or more aspects;

FIG. 4 illustrates an exemplary, non-limiting welder of a welding system;

FIG. 5 illustrates an exemplary, non-limiting embodiment of a welding system including an exemplary, non-limiting embodiment of a power supply;

FIG. 6 illustrates an exemplary, non-limiting embodiment of a welding controller according to one or more aspects; and

FIG. 7 is a flow diagram of method for controlling welding output responsive to a condition of the welding system.

### DETAILED DESCRIPTION OF THE INVENTION

Embodiments of the invention relate to systems and methods for providing a variable, allowable welding output of a welding system. Responsive to a condition of a power supply, the welding system itself, and/or an environment of the welding system, the welding system can determine a limit to an achievable welding output. The welding system can control at least one of a settable value for a welding output or generation of the welding output to enforce the limit.

As used herein, the term “welding” refers to an arc welding or plasma arc cutting or machining process. Example arc welding processes include shielded metal arc welding (SMAW) (e.g., stick welding), flux cored arc welding (FCAW), and other welding processes such as gas metal arc welding (GMAW), gas tungsten arc welding (GTAW), and the like. The term “welder”, as utilized herein, includes a machine or apparatus for welding or a machine or apparatus for plasma cutting. That is, a welder is capable of performing or implementing an arc welding process or system of providing a plasma arc to cut or machine an object. The term “welding system” refers to a system of one or more machines or apparatuses that generates an electric arc that may be applied to form a weld or remove material for purposes of cutting or machining an object. For example, a welding system can include a power supply coupled to the welder. As utilized herein, a “power supply” refers to a system, machine, or apparatus for providing input electrical power to the welder. A power supply can include one or more power sources that independently or jointly provide the input electrical power. Examples of power sources include a power grid or interface thereto, a battery or bank of batteries, a fuel cell, a generator coupled to source of mechanical energy (e.g. an internal combustion engine), or the like.

According to an aspect, an attainable welding output power generally follows from an input power from the power supply. An amount of input power deliverable from the power supply can depend on various conditions and/or circumstances related to the power supply, the welder, and/or the environment. Accordingly, given that the amount of input power deliverable can be variable, the attainable welding output power is also variable. For example, a hybrid welding system can include a welder and a power supply including an engine-driven generator and a battery system. When the generator becomes inoperable (e.g. the engine runs out of fuel), the amount of input power deliverable changes to only what the battery system provides. Thus, the attainable welding output power changes to a value derived from power delivered from the battery system alone. A similar change can occur in such a hybrid welding system when, for example, a charge of the battery system runs low, which leaves the engine-driven generator to solely provide the input power.

Other factors beyond power source availability can impact the amount of input power deliverable and, consequently, the attainable or achievable welding output power. For instance, a condition of a power source influences the amount of input power. The condition can relate to a physical condition or an operational condition of the power source, or an environmental condition associated with an environment in which the power source is located. Some exemplary power source or power supply conditions include, without limitation: a fuel type (e.g. gasoline, diesel, etc.); fuel properties (e.g. characteristics, composition, etc.) which can be variable depending on fuel mixture; an operating temperature (e.g. temperature of or within the power source); a coolant level; oil or lubrication level; an air flow; an air filter condition; an amount of fuel; a manufacturing date (or time since manufacture); a operational time (e.g. time in service); materials utilized in components of the power source; expected lifetime of components or materials; a number of cycles (for battery systems); and the like. To illustrate, an engine-driven generator utilizing a fuel consisting of gasoline blended with ethanol may provide less power output than the same engine-driven generator deriving power form a pure gasoline fuel. In another illustration, a clogged air filter can restrict an amount of air reaching a cylinder of the engine resulting in a less efficient or less energetic combustion reaction, which may also create a reduction in deliverable power. In yet another example, the deliverable power can decrease over time as the power source, or components thereof, age and/or wear through use. For example, an engine-driven generator, through age and wear, can begin to lose compression, which leads to a reduction in deliverable power.

While having an impact on output (i.e. deliverable power), the physical or operational condition of the power source, as described above, can also influence efficiency such as fuel efficiency for engine-driven generators or charge/discharge efficiency for battery systems. For instance, different fuel mixtures can be consumed at different rates. Operating temperature may also affect efficiency. That is, an engine-driven generator, at a higher operating temperature, may operate less efficiently than at a lower operating temperature. In other words, operating temperature, fuel composition, and/or other parameters specifying aspects of the physical or operational condition of the power source can impact a brake specific fuel consumption of the power source.

According to an aspect, a welding system can utilize information indicative of a physical or operational condition of a power supply (or power source) to determine a deliverable amount of power from the power supply to a welding power source (e.g., chopper, inverter, etc.). In addition, the welding system can also determine an efficiency of the power supply based on the information. Accordingly, the welding system can identify, not only the amount of power deliverable, but also an amount of time that a given level of power is available. For battery systems, the welding system can utilize the information indicative of the physical or cooperation condition to determine a capacity, which indicates the amount of time a particular output can be maintained. For an engine-driven generator, the welding system can utilize a fuel amount in connection with efficiency to determine the amount of time a power output is available.

Environmental factors can also impact a power supply. For example, ambient temperature, ambient pressure, relative humidity, oxygen level or density, and the like can influence the amount of deliverable power from an engine-driven generator and/or an efficiency of the engine-driven generator. For instance, power output decreases as ambient pressure decreases (e.g. altitude increase). Also, cooler temperatures may increase oxygen density relative to warmer temperatures. Similarly, ambient temperature can alter characteristics of a battery system. Thus, the welding system can also utilize information indicative of environmental conditions to determine the deliverable amount of power from the power supply and/or the efficiency of the power supply.

Condition information (e.g. physical information, operational information, environmental information, etc.) can be provided to the welding system for the determination of an amount of deliverable power from a power source and/or an amount of time a power level is sustainable. The condition information can be input by an operator via a user interface. For example, the operator can select an ambient temperature, a fuel type, or other variables from which the welding system can utilize to determine an operational limit. In another aspect, the condition information can be obtained by one or more sensors. Such sensors can measure environmental conditions such as temperature, pressure, oxygen level, humidity, or the like. Other sensors can be deployed to measure operational conditions such as operating temperature of a power source, fuel type or composition (e.g. sensors measuring specific gravity or hydrocarbon content), fuel capacity, fluid levels, air flow, and/or any other condition described above or capable of impacting power output, efficiency, or output duration. Still further, the power supply can include a controller configured to monitor a physical, operational, and/or environmental status of the power supply. The controller of the power supply can generate condition information based on the monitoring. The condition information can be transmitted to a controller of the welding system, for example.

In a further aspect, the welding system can utilize an amount of power available from a power source (and/or an amount of time a given power level can be delivered) to control a welding output from a welding power source. As utilized herein, a “welding output” refers to an output current, an output voltage, or both, which is generated by a welding power source to produce a weld or machine metal when used as a plasma cutter. The welding system controls the output current, the output voltage, or both to prevent the welding output power from exceeding the amount of power available from the power source. In one example, the welding power source can be directly controlled to enforce this limit. In another example, the welding system can enforce this limit by constraining settable values of a welding output preset. For example, the welding system can configure a user interface of the welding system to prevent an operator from establishing a welding output preset beyond a capability of the power source. It is to be appreciated that the welding system, either through pre-determined data or through analysis of physical or operation condition information of the welding power source, determines an efficiency of welding power source. That is, for a given power level delivered by the power supply, the welding system can determine a corresponding welding output power based on the efficiency of the welding power source.

By way of illustration, a welding system can have a rating or capability to generate a welding output of 333 A at 30V (i.e. approximately 10,000 W), but condition information indicates a deliverable power from the power source which corresponds to a welding output power of 9000 W. Accordingly, the welding system can control generation of the welding output or the user interface to limit the welding output to 300 A at 30V, for example.

In one embodiment, a welding system is provided. The welding system can include an interface configured to receive a welding output preset. In addition, the welding system can include a welding power source configured to generate a welding output for performing a welding process. The welding output is based at least in part on the welding output preset received. Further, the welding system can include a welding controller configured to control the welding power source to generate the welding output. The welding controller is further configured to enforce a limit on the welding output preset.

According to one or more examples, the welding controller is further configured to determine the limit on the welding output preset responsive to a condition of at least one of the welding system or an environment of the welding system. The welding controller can be configured to receive a signal indicative of the condition. A sensor can be provided that generates the signal indicative of the condition and communicates the signal to the welding controller.

The welding controller is further configured to determine, based on the condition, an amount of input electrical power deliverable to the welding power source. The welding controller is further configured to determine, based on the amount of input electrical power deliverable, an achievable welding output. The welding controller is further configured to enforce the limit on the welding output preset to restrict the welding output preset to within the achievable welding output.

The welding system can also include a power supply configured to provide an input electrical power to the welding power source. The power supply can include an engine for driving a generator to produce the input electrical power and an engine controller configured to communicate, to the welding controller, at least one of a condition of the engine, a condition of the generator, or an amount of input electrical power deliverable to welding power source. Alternatively, the power supply can include a battery for delivering the input electrical power and a battery management system to communicate, to the welding controller, at least one of a condition of the battery or an amount of input electrical power deliverable to the welding power source.

In yet another example, the interface is a user interface operable by an operator to establish the welding output preset. The welding controller is further configured to output the limit on the welding output preset to the user interface. In addition, the welding controller is further configured to restrict operation of the user interface to enforce the limit on the welding output preset.

According to another embodiment, a method is provided. The method includes receiving information indicative of a condition of a welding system. In an example, the condition influences an amount of input electrical power deliverable to a welding power source of the welding system for generating a welding output. The method can also include determining a limit on the welding output based on the information indicative of the condition. The limit indicates an achievable welding output due to the condition. Further, the method can include controlling the welding output of the welding system to enforce the limit determined.

According to one aspect, receiving information indicative of the condition of the welding system can include receiving an input via a user interface. Alternatively, receiving information indicative of the condition can include receiving a signal from a controller associated with a power supply of the welding system. In another aspect, receiving information indicative of the condition can include receiving a signal from a sensor configured to measure the condition.

The information indicative of the condition can include one or more values descriptive of the condition. Thus, the method can also include calculating the limit on the welding output based on the one or more values. Calculating the limit can include utilizing a model configured to relate the one or more values to the limit on the welding output. The model can include a predefined table that correlates condition variables to the achievable welding output.

In yet another example, controlling the welding output can include restricting the welding output generated by the welding power source in accordance with the limit. In another example, controlling the welding output comprises restricting a user interface operable to establish a welding output preset to prevent setting the welding output preset to exceed the limit.

In a further embodiment, a computer-readable storage medium is provided. The computer-readable storage medium stores computer-executable instructions that, when executed by a processor, configure the processor to: receive information indicative of a condition of a welding system, wherein the condition influences an amount of input electrical power deliverable to a welding power source of the welding system for generating a welding output; determine an achievable welding output due to the condition based on the information indicative of the condition; and control the welding output of the welding system to constrain the welding output within a limit established by the achievable welding output.

The computer-readable storage medium further stores computer-executable instructions that configure the processor to receive a signal from a sensor configured to measure a value associated with the condition and determine the achievable welding output based on the signal received from the sensor. In another aspect, the computer-readable storage medium further stores computer-executable instructions that configure the processor to receive a signal from a power supply of the welding system, the signal indicative of the amount of input electrical power deliverable to the welding power source and determine the achievable welding output based on the amount of input electrical power deliverable. The computer-readable storage medium further stores computer-executable instructions that configure the processor to utilize a model correlating condition values to output values with the information indicative of the condition to determine the achievable welding output.

According to further aspects, the computer-readable storage medium of claim stores computer-executable instructions that configure the processor to control the welding power source to prevent the welding output from exceeding the achievable welding output, to output an indication of the achievable welding output to a user interface of the welding system, and to control a user interface of the welding system to restrict a settable value for a welding output preset to within the limit. The computer-readable storage medium can further store computer-executable instructions that configure the processor to: determine the amount of input electrical power deliverable to the welding power source based on the information indicative of the condition; and determine the achievable welding output based on the amount of input electrical power deliverable to the welding power source.

Exemplary embodiments will now be described with reference to the drawings. The examples and drawings are illustrative only and not meant to limit the invention, which is measured by the scope and spirit of the claims. Like reference numerals refer to like elements throughout.

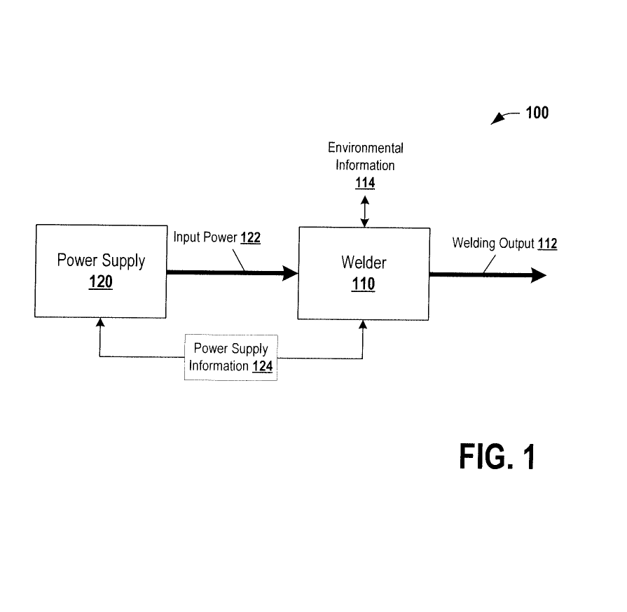

FIG. 1 illustrates one example of a welding system 100 capable of enforcing a limit on welding output based a condition. The condition, as described above, can be an environmental condition of an environment in which the welding system 100 is located. The condition can also be a physical or operational condition of various components of the welding system 100. As shown in FIG. 1, the welding system 100 can include a welder 110 that generates a welding output 112 usable for performing a weld and a power supply 120 that provides an input power 122 to the welder 110 for conversion to the welding output 112.

In an aspect, the welder 110 can control generation of the welding output 112 based on input power 122. More particularly, as a magnitude of input power 122 at any given point in time corresponds to an amount of demand (i.e. draw) from welder 110, welder 110 can control welding output 112 in accordance with a demand limit. In one embodiment, the demand limit can refer to a maximum amount of power that can be drawn from power supply 120. That is, the demand limit corresponds to a maximum amount of power that power supply 120 can deliver to welder 110. In another embodiment, the demand limit can refer to a maximum sustainable amount of power deliverable by power supply 120. For instance, power supply 120 may be able to provide input power 122 at a magnitude congruent with a maximum rating, but only for a short period of time. Accordingly, the maximum sustainable amount of power deliverable refers to an amount of power deliverable for a period of time corresponding to a predetermined threshold. The threshold can be an average time for producing a weld or cut.

To determine the demand limit, welder 110 can collect environmental information 114 indicative of a condition of an environment in which welding system 100 is located and power supply information 124 indicative of a condition of power supply 120. As described previously, this information can be utilized by welder 110 to determine an amount of power deliverable by power supply 120 (e.g. a maximum output of power supply 120 under the conditions) and/or an efficiency of power supply 120 (e.g. a rate of fuel consumption or discharge). With these determined quantities, welder 110 can determine the demand limit. That is, welder 110 can determine a maximum power that can be drawn from power supply 120 and/or a maximum power that can be sustainably drawn for at least a usable period of time. Based on the demand limit, welder 110 can determine a welding output limit. For instance, welder 110 can utilize a conversion efficiency (e.g. ratio between output power and input power) to identify a limit on welding output power. This limit on output power can be further deconstructed to individual limits on welding output current and/or welding output voltage. Welder 110 can enforce the limits on welding output 112 to prevent over drawing power supply 120. For example, demanding more power than deliverable can damage components and/or interrupt input power 122 (e.g. slow or stall an engine driving a generator), which can lead to poor welds and/or render welding system 100 inoperable.

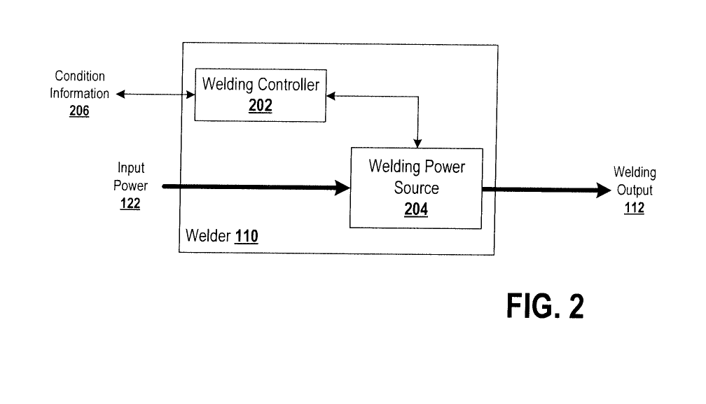

Turning to FIG. 2, illustrated is a schematic block diagram of an exemplary, non-limiting embodiment of welder 110 of welding system 100. Welder 110 can include a welding controller 202, which can be, for example, a microcontroller, a system-on-a-chip, a microprocessor, or a logic circuit implementing aspects described herein. Welder 110 further includes a welding power source 204 configured to convert input power 122 to welding output 112. Welding power source 204 can be a inverter-based power source, a chopper-based power source, a transformer-based power source, or substantially any other form of power source or circuit suitable to direct or convert input power 122 to create a weld or cut.

As shown in FIG. 2, welding controller 202 can receive condition information 206. For example, condition information 206 can be received from the environment (i.e. as environment information 114), from power supply 120 (i.e. as power supply information 124), and/or as input from an operator. Welding controller 202, as described above, can determine various capabilities and/or limits of welding system 100 based on the condition information 206. For example, welding controller 202 can identify limits on welding output 112 generated by welding power source 204. Welding controller 202 can control a welding process, via control of welding power source 204 for example, so as to enforce the identified limits. For instance, welding controller 202 can override predetermined configurations of welding power source 204 and/or an established welding output preset to restrict welding output 112 to sustainable levels according to the identified limits.

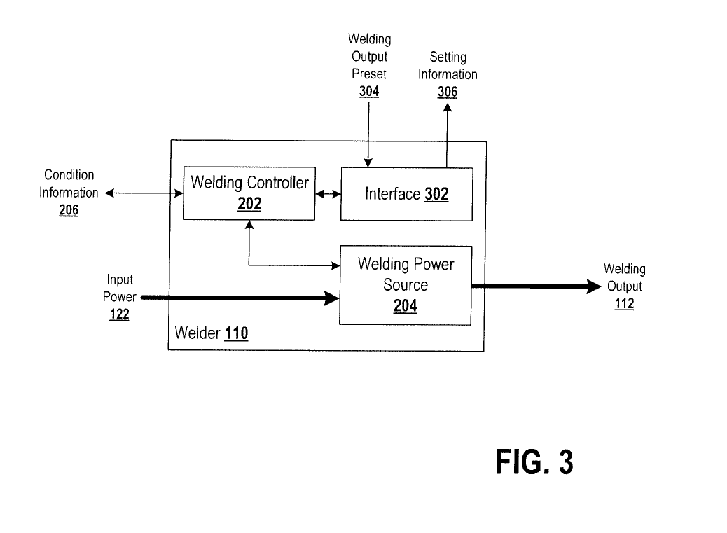

Turning to FIG. 3, a schematic block diagram of an exemplary, non-limiting embodiment of welder 110 is depicted. According to this embodiment, welder 110 includes an interface 302. In one example, interface 302 can be a communication interface configured to communicate data to and/or from welder 110. Interface 302 can include various wired or wireless interfaces or connection points. For instance, interface 302 can include video ports, serial ports, parallel ports, USB ports, or other communication ports. Interface 302 can also include a wireless interface to enable communications via a wireless protocol such as WiFi or other wireless LAN protocol; Bluetooth, Wireless USB, or other similar RF protocol; a cellular radio protocol; an infrared protocol; or the like.

In another example, interface 302 can be a user interface operable by an operator of welding system 100. The user interface can include various controls (e.g. knobs, buttons, switches, keys, etc.) and output devices (e.g. LEDs, displays, etc.). Moreover, the user interface can include a touch-screen device suitable to acquire input and display output.

As shown in FIG. 3, welder 110 can receive a welding output preset 304 via interface 302. The welding output preset 304 can be a desired welding output provided by the operator. For instance, the welding output preset 304 can indicate an output current and/or an output voltage desired. Further, interface 302 can output or communicate setting information 306 indicating current settings, an established welding output preset, or the like. The setting information 306 can further indicate an achievable and/or sustainable welding output based on condition information 206. The operator can supply welding output preset 304 in accordance with the achievable welding output.

In additional aspects, interface 302 can output or communicate feedback when welding output preset 304 exceeds achievable limits under conditions indicated by condition information 206. The feedback can indicate the welding output preset 304 is disallowed. Alternatively, welding controller 202 can reduce welding output preset 304 to achievable levels when determined limits are exceeded. Accordingly, the feedback or setting information 306 output or communicated via interface 302 can indicate the reduction. Further still, in the case of a user interface, the welding controller 202 can configure the user interface to disable a possibility of an operator establishing welding output preset 304 above allowable limits.

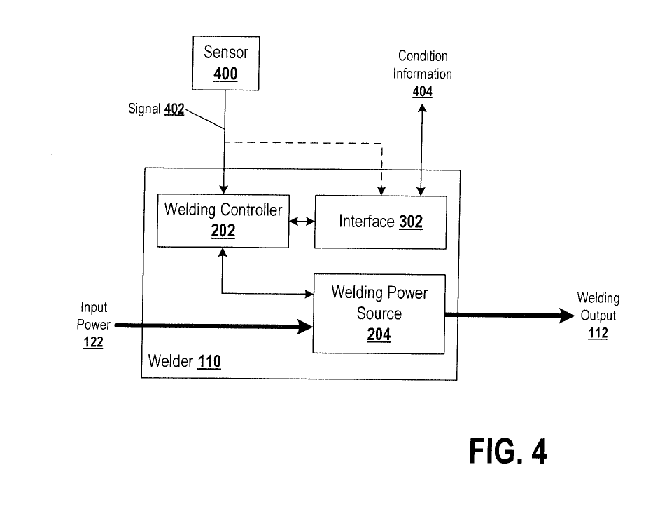

FIG. 4 illustrates a schematic block diagram of another embodiment of welder 110. As shown in FIG. 4, a sensor 400 is provided that is configured to measure a property, characteristic, or condition. The measured variable can be associated with the environment, the welder 110, the power supply 120, or any other component of welding system 100. Sensor 400, responsive to the condition, outputs a signal 402 indicative of a measured value corresponding to the condition. Accordingly, in an aspect, signal 402 can be included as a part of condition information 206, environmental information 114, and/or power supply information 124. Thus, signal 402 can indicate a level for one or more of the properties or conditions described previously, and can be utilized by welding controller 202 to determine an amount of power deliverable to welding power source 204, an efficiency of power supply 120, an efficiency of welding power source 204, and/or an period of time a given level of power can be maintained.

In an embodiment, sensor 400 can be integrated with the welding system 100. For example, the sensor 400 can be communicatively coupled to welder 110 such that signal 402 is provided directly to the welding controller 202. That is, signal 402 can be transmitted on a dedicated line or communication bus reserved for condition information. Physically, sensor 400 can be located and/or coupled to welder 110 or power supply 120, depending on the condition measured. In another embodiment, sensor 400 can be a separate component from the welding system 100. For example, sensor 400 can be a commercial off-the-shelf device and communicatively coupled to welder 110 via interface 302. For instance, sensor 400 can transmit signal 402 via a wired or wireless medium to interface 302.

According to another aspect, interface 302 can include a user interface operable by an operator to input information. Input from the operator via the user interface can include condition information 404. For instance, the operator can input a type of fuel utilized with an engine-drive generator, a temperature, an altitude, or substantially any other data associated with an environmental condition, an operational condition, or a physical condition associated with welding system 100 or sub-components thereof. Thus, as shown in FIG. 4, the welder 110 can acquire information indicative of a condition from sensors or as input from an operator.

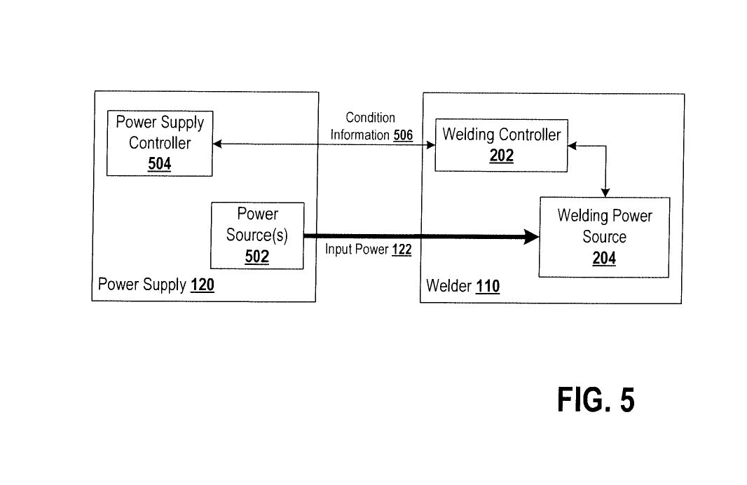

Turning to FIG. 5, illustrated is a block diagram of another exemplary embodiment of welding system 100. In FIG. 5, power supply 120 can include a power supply controller 504 and one or more power sources 502. Power sources 502 can include an engine-driven generator, a battery system, a coupling to deliver line power, and/or substantially any other machine or apparatus capable to providing input power 122 to welding power source 204. Power supply controller 504 monitors and controls operation of power sources 502. For a battery system, power supply controller 504 can be a battery management system. For an engine-drive generator, power supply controller 504 can include an engine control unit (ECU) and/or a generator control unit.

In an aspect, power supply controller 504 can monitor power sources 502 and/or an environment to collect data indicative of a condition. For instance, power supply controller 504 can interface with sensors similar to welding controller 202 as shown in FIG. 4. Power supply controller 502 can transmit collected data to welding controller 202 as condition information 506.

As described above in connection with previous embodiments, welding controller 202 utilizes condition information to determine an amount of power available or deliverable from power supply 120, a duration that the amount of power can be supplied, and/or a power level for the welding output 112 that is achievable. However, power supply controller 504, in an aspect, can utilize the collected data to determine the amount of power available or deliverable from power sources 502, an efficiency of power sources 502, and/or a period of time a given power level can be provided. Once determined, the power supply controller 502 can communicate these values to welding controller 202 as condition information 506. Accordingly, welding controller 202 need not be responsible for collecting condition data or for computations from such raw condition data. Rather, the welding controller can utilize reports from power supply controller 504 to determine limits on welding output.

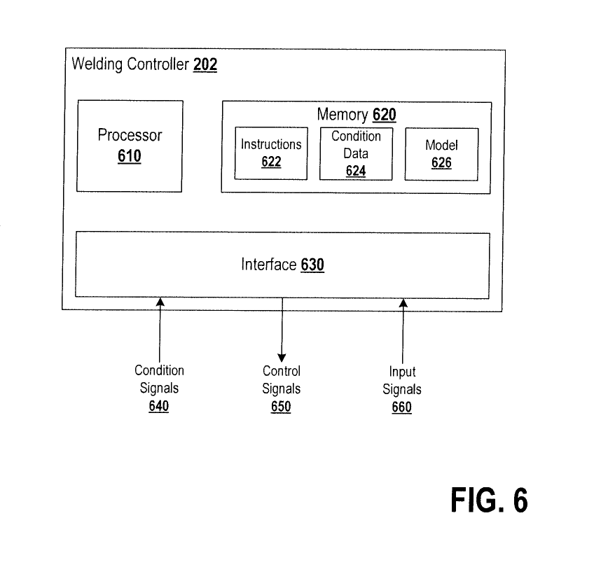

Referring to FIG. 6, illustrated a schematic block diagram of an exemplary, non-limiting embodiment of welding controller 202 according to one or more aspects. As shown in FIG. 6, welding controller 202 can be a microcontroller that includes a processor 610, a memory 620, and an interface 630. Processor 610 is configured to execute computer-executable instructions, such as instructions 622 stored by memory 620, for example. Instructions 622 comprise software executable by processor 610 to configure welding controller 202 to perform aspects described herein. Memory 620 can be non-transitory, computer-readable storage media including volatile storage media (e.g. a random access memory, a data cache, a register) and/or non-volatile storage media such as a hard drive, flash memory, portable media (e.g. floppy disk, USB drive, optical disc, etc.), a read-only memory, etc. For the purposes of this description, the various forms of computer-readable storage media described above are collectively shown and referred to as memory 620. Interface 630 can be a communications interface to enable welding controller 202 to communicate with other components such as power supply 120, welding power source 204, sensor 400, etc. In one example, interface 630 can include general purpose input/output (I/O) pins, which can be coupled to various signal lines or circuit paths to transmit or receive signals. In another example, the interface 630 can be a connection to a data bus. In yet another example, interface 630 can be a wireless interface.

Welding controller 202, via interface 630, can receive condition signals 640 indicative of one or more conditions (e.g. environmental conditions, physical conditions, operational conditions, etc.) associated with the welding system 100. Condition data 624, stored by memory 624, can be generated based on condition signals 640. Processor 610 can employ model 626 with condition data 624 to determine, for example, an amount of power deliverable by power supply 120, an efficiency of power supply 120, a duration that power supply 120 can provide a given level of power, an achievable or maintainable welding output, and/or a limit to enforce on welding output. Based on these determined quantities or values, welding controller 202 can generate control signals 650 transmitted by interface 630. Control signals 650 can be transmitted to welding power supply 204 to limit welding output 112 generated thereby, or to a user interface to inform an operator of input limits (e.g. welding output preset limits) and/or to normalize inputs in accordance with the limits. Moreover, interface 630 can receive input signals 660 (from interface 302 for example), which can be utilized to generate or supplement condition data 624, or establish settings (e.g. output presets) by which welding controller 202 implements via control signal 650.

Model 626 can be a set of mathematical relationships correlating various conditions to deliverable power, efficiency, and/or duration as described above. Accordingly, processor 610 can utilize the set of mathematical relationships with condition data 624 to calculate deliverable power, efficiency, and/or duration. In another example, model 626 can be based on empirical data. For instance, for the respective conditions and, specifically respective levels or values for the conditions, results can be experimentally measured and collected. The results can be, for example, actual measurements of power output, efficiency, and delivery duration under varying conditions. The results can be tabulated and the tables, which can be form of model 626, utilized to determine or interpolate desired quantities based on condition data 624 gathered by welding controller 202. In another example, the empirical data is utilized to generate to train model 626 via artificial intelligence or machine learning techniques. For instance, model 626 can be a neural network or other classification scheme that is trained on the empirical data to develop relationships between conditions and power output. The developed relationships can be utilized to determine welding power output from new condition inputs in situ. According to this example, model 626 can include or involve, for instance, a neural network, a decision tree, an association rule, a support vector machine, a Bayesian network, genetic algorithms, or the like.

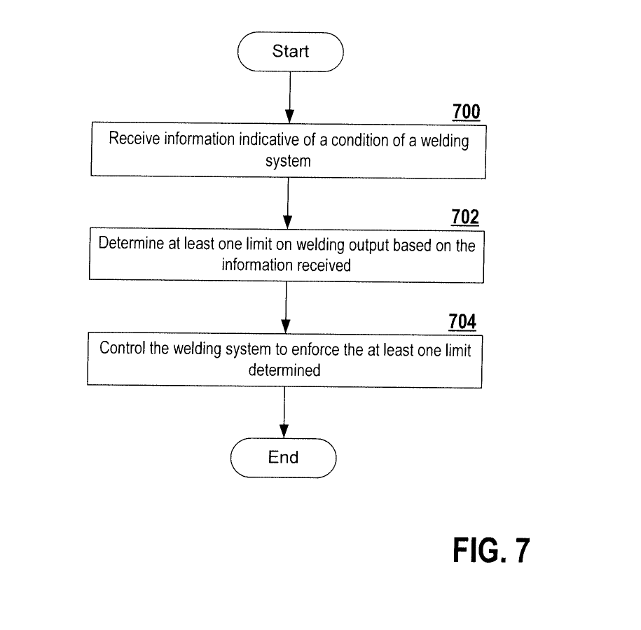

In view of the exemplary devices, apparatuses, systems, and elements described supra, a methodology that may be implemented in accordance with the disclosed subject matter will be better appreciated with reference to a flow chart and/or methodology of FIG. 7. The methodology and/or flow diagram is shown and described as a series of blocks. The claimed subject matter is not limited by the order of the blocks, as some blocks may occur in different orders and/or concurrently with other blocks from what is depicted and described herein. Moreover, not all illustrated blocks may be required to implement the method and/or flow diagram described hereinafter.

FIG. 7 illustrates a method for controlling a welding system based on a condition of the welding system. The method of FIG. 7 can be implemented by welding system 100, welder 110, and/or power supply 120 illustrated in FIGS. 1-6. At 700, information indicative of a condition of a welding system is received. The information can relate to environmental conditions of an environment of the welding system, physical conditions of the welding system or components thereof, and/or operational conditions of the welding system or components thereof. The information can include values for parameters, properties, or characteristics that specify or define the condition. In one example, the information can be received from one or more sensors configured to measure the parameters defining the condition. In another example, the information can be provided at user input. Still further, as opposed to data representing parameters of the condition the information indicative of the condition can be a result or effect of the condition. For instance, the information received can be a report from a power source providing input power to a welding power source. The report can indicate a maximum power that can be provided due to the condition.

At 702, at least one limit on welding output is determined based on the information received. In one example, the determination of the at least one limit can include intermediary determinations of an amount of power deliverable or drawable from a power source, a time period a given power level can be drawn or delivered from the power source, and/or an efficiency of the power source. The intermediary determinations can provide a basis for the at least one limit on the welding output. In another example, the information received can include these intermediary determinations. The at least one limit can correspond to a welding output maintainable for a period of time sufficient to produce a weld. Alternatively, the at least one limit can correspond to a welding output related to the amount of power deliverable in accordance with an efficiency of a power converter of the welding system. The determinations can be generated with one or more mathematical relationships or equations, one or more tables from which the determinations can be interpolated, or with a model generated with artificial intelligence or machine learning techniques.

At 704, the welding system is controlled to enforce the at least one limit. For instance, a power conversion system or welding power source can be controlled to generate a welding output in accordance with the limit. In another example, a settable value for a welding output preset can be constrained based on the limit.

While the embodiments discussed herein have been related to the systems and methods discussed above, these embodiments are intended to be exemplary and are not intended to limit the applicability of these embodiments to only those discussions set forth herein. The systems and methodologies discussed herein are equally applicable to, and can be utilized in, systems and methods related to arc welding, laser welding, brazing, soldering, plasma cutting, waterjet cutting, laser cutting, and any other systems or methods using similar control methodology, without departing from the spirit of scope of the above discussed inventions. The embodiments and discussions herein can be readily incorporated into any of these systems and methodologies by those skilled in the art.

The above examples are merely illustrative of several possible embodiments of various aspects of the present invention, wherein equivalent alterations and/or modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component, such as hardware, software, or combinations thereof, which performs the specified function of the described component (e.g., that is functionally equivalent), even though not structurally equivalent to the disclosed structure which performs the function in the illustrated implementations of the invention. In addition although a particular feature of the invention may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising.”

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that are not different from the literal language of the claims, or if they include equivalent structural elements with insubstantial differences from the literal language of the claims.

The best mode for carrying out the invention has been described for purposes of illustrating the best mode known to the applicant at the time. The examples are illustrative only and not meant to limit the invention, as measured by the scope and merit of the claims. The invention has been described with reference to preferred and alternate embodiments. Obviously, modifications and alterations will occur to others upon the reading and understanding of the specification. It is intended to include all such modifications and alterations insofar as they come within the scope of the appended claims or the equivalents thereof.

What is claimed is:

1. A welding system, comprising:
an interface configured to receive a welding output preset;
a welding power source configured to generate a welding output for performing a welding process, the welding output being based at least in part on the welding output preset received; and
a welding controller configured to control the welding power source to generate the welding output, wherein the welding controller is further configured to enforce a limit on the welding output preset.

2. The welding system of claim 1, wherein the welding controller is further configured to determine the limit on the welding output preset responsive to a condition of at least one of the welding system or an environment of the welding system.

3. The welding system of claim 2, wherein the welding controller is further configured to receive a signal indicative of the condition.

4. The welding system of claim 3, further comprising a sensor configured to generate the signal indicative of the condition and to communicate the signal to the welding controller.

5. The welding system of claim 2, wherein the welding controller is further configured to determine, based on the condition, an amount of input electrical power deliverable to the welding power source.

6. The welding system of claim 5, wherein the welding controller is further configured to determine, based on the amount of input electrical power deliverable, an achievable welding output.

7. The welding system of claim 6, wherein the welding controller is further configured to enforce the limit on the welding output preset to restrict the welding output preset to within the achievable welding output.

8. The welding system of claim 1, further comprising a power supply configured to provide an input electrical power to the welding power source.

9. The welding system of claim 8, wherein the power supply comprises:
an engine for driving a generator to produce the input electrical power; and
an engine controller configured to communicate, to the welding controller, at least one of a condition of the engine, a condition of the generator, or an amount of input electrical power deliverable to welding power source.

10. The welding system of claim 8, wherein the power supply comprises:
a battery for delivering the input electrical power; and
a battery management system to communicate, to the welding controller, at least one of a condition of the battery or an amount of input electrical power deliverable to the welding power source.

11. The welding system of claim 1, wherein the interface is a user interface operable by an operator to establish the welding output preset.

12. The welding system of claim 11, wherein the welding controller is further configured to output the limit on the welding output preset to the user interface.

13. The welding system of claim 11, wherein the welding controller is further configured to restrict operation of the user interface to enforce the limit on the welding output preset.

14. The welding system of claim 1, wherein the welding output is used to form a weld.

15. The welding system of claim 1, wherein the welding output is used to machine or cut.

16. A method, comprising:
receiving information indicative of a condition of a welding system, wherein the condition influences an amount of input electrical power deliverable to a welding power source of the welding system for generating a welding output;
determining a limit on the welding output based on the information indicative of the condition, wherein the limit indicates an achievable welding output due to the condition; and
controlling the welding output of the welding system to enforce the limit determined.

17. The method of claim 16, wherein receiving information indicative of the condition of the welding system comprises receiving an input via a user interface.

18. The method of claim 16, wherein receiving information indicative of the condition comprises receiving a signal from a controller associated with a power supply of the welding system.

19. The method of claim 16, wherein receiving information indicative of the condition comprises receiving a signal from a sensor configured to measure the condition.

20. The method of claim 16, wherein the information indicative of the condition includes one or more values descriptive of the condition, the method further comprising calculating the limit on the welding output based on the one or more values.

21. The method of claim 20, wherein calculating the limit comprises utilizing a model configured to relate the one or more values to the limit on the welding output.

22. The method of claim 21, wherein the model comprises a predefined table that correlates condition variables to the achievable welding output.

23. The method of claim 16, wherein controlling the welding output comprises restricting the welding output generated by the welding power source in accordance with the limit.

24. The method of claim 16, wherein controlling the welding output comprises restricting a user interface operable to establish a welding output preset to prevent setting the welding output preset to exceed the limit.

25. A computer-readable storage medium having stored thereon computer-executable instructions that, when executed by a processor, configure the processor to:
receive information indicative of a condition of a welding system, wherein the condition influences an amount of input electrical power deliverable to a welding power source of the welding system for generating a welding output;
determine an achievable welding output due to the condition based on the information indicative of the condition; and
control the welding output of the welding system to constrain the welding output within a limit established by the achievable welding output.

26. The computer-readable storage medium of claim 25, further storing computer-executable instructions that configure the processor to:
receive a signal from a sensor configured to measure a value associated with the condition; and
determine the achievable welding output based on the signal received from the sensor.

27. The computer-readable storage medium of claim 25, further storing computer-executable instructions that configure the processor to:
receive a signal from a power supply of the welding system, the signal indicative of the amount of input electrical power deliverable to the welding power source; and
determine the achievable welding output based on the amount of input electrical power deliverable.

28. The computer-readable storage medium of claim 25, further storing computer-executable instructions that configure the processor to utilize a model correlating condition values to output values with the information indicative of the condition to determine the achievable welding output.

29. The computer-readable storage medium of claim 25, further storing computer-executable instructions that configure the processor to control the welding power source to prevent the welding output from exceeding the achievable welding output.

30. The computer-readable storage medium of claim 25, further storing computer-executable instructions that configure the processor to output an indication of the achievable welding output to a user interface of the welding system.

31. The computer-readable storage medium of claim 25, further storing computer-executable instructions that configure the processor to control a user interface of the welding system to restrict a settable value for a welding output preset to within the limit.

32. The computer-readable storage medium of claim 25, further storing computer-executable instructions that configure the processor to:
determine the amount of input electrical power deliverable to the welding power source based on the information indicative of the condition; and
determine the achievable welding output based on the amount of input electrical power deliverable to the welding power source.

33. The computer-readable storage medium of claim 25, wherein the welding output forms a weld.

34. The computer-readable storage medium of claim 25, wherein the welding output is used to machine or cut.
